(19) United States
(12) Patent Application Publication
(10) Pub. No.: US 2026/0200273 A1
(43) Pub. Date: Jul. 16, 2026

(54) METHOD FOR DETECTING HEAVY-DUTY VEHICLE WHEEL END CONDITIONS

(71) Applicant: Hendrickson USA, L.L.C., Schaumburg, IL (US)

(72) Inventors: Damon Delorenzis, Plainfield, IL (US); Jeff R. Zawacki, Channahon, IL (US)

(21) Appl. No.: 19/442,117

(22) Filed: Jan. 7, 2026

Related U.S. Application Data
(60) Provisional application No. 63/745,375, filed on Jan. 15, 2025.

(51) Int. Cl. B60C 23/06; G01M 13/045; G01M 17/013

(52) U.S. Cl. CPC B60C 23/062; G01M 13/045; G01M 17/013

(57) ABSTRACT

A method for detecting a wheel end condition of a heavy-duty vehicle. The method includes the steps of providing a wheel end sensor that includes sensor instrumentation and mounting the wheel end sensor to a rotatable component associated with a wheel end of the heavy-duty vehicle. A tangential acceleration signal is then collected from the sensor instrumentation of the wheel end sensor during operation of the heavy-duty vehicle, which is then processed via suitable means to obtain a metric. The metric is then compared to a predetermined limit to determine whether a wheel end condition exists.

### CROSS-REFERENCE TO RELATED APPLICATION

This application claims the benefit of U.S. Provisional Patent Application Serial No. 63/745,375 filed on January 15, 2025.

### BACKGROUND

### Technical Field

The disclosed subject matter relates to sensors for heavy-duty vehicles, such as tractor-trailers or semi-trailers, and in particular, to sensors associated with the wheel ends of heavy-duty vehicles. More particularly, the disclosed subject matter is directed to a method for detecting potential problems or wheel end conditions associated with one or more components of the wheel ends of heavy-duty vehicles, such as those pertaining to wheel bearing health, tire imbalance, tire uniformity and health, and/or other wheel end conditions, using one or more wheel end sensors mounted to respective components of the wheel ends of the vehicle. The method for detecting heavy-duty vehicle wheel end conditions of the disclosed subject matter provides relatively increased accuracy, robustness, and reliability in detecting such wheel end conditions associated with components of the wheel ends as compared to prior art methods for detecting heavy-duty vehicle wheel end conditions via identification of signal frequency characteristics of the wheel end conditions. This increases a vehicle operator's confidence in and acceptance of the method and enables early detection of specific potential problems associated with such components, thereby allowing a vehicle operator to address the wheel end conditions and minimize compounding issues associated with the conditions and improving overall vehicle safety, as well as reducing vehicle operational and maintenance costs.

Moreover, the method for detecting heavy-duty vehicle wheel end conditions of the disclosed subject matter enables detection of one or more wheel end conditions associated with one or more components of the wheel ends of heavy-duty vehicles, as well as enables monitoring of one or more operating conditions associated with the wheel ends, such as wheel speed, via a single signal or reading from a single instrument or detector of the wheel end sensor. This minimizes energy consumption of the wheel end sensor, minimizes cost and complexity of the wheel end sensor, reduces the overall cost of operating the heavy-duty vehicle, and improves market competitiveness of the method for detecting heavy-duty vehicle wheel end conditions as compared to prior art methods for detecting heavy-duty vehicle wheel end conditions.

The wheel ends of heavy-duty vehicles typically include wheel end assemblies mounted on the ends of the axles of the vehicles, as is known. Heavy-duty vehicles include trucks and tractor- trailers or semi-trailers, trailers thereof, and the like. Each wheel end assembly typically includes a wheel hub rotatably mounted on a wheel bearing assembly that is immovably mounted on an axle spindle located on a respective outboard end of the axle. The wheel bearing assembly includes an inboard wheel bearing and an outboard wheel bearing, which may be separated by a bearing spacer. An axle spindle nut assembly secures the wheel bearing assembly on the axle spindle by threadably engaging threads that are formed on the outer diameter of the outboard end of the axle spindle. In addition to retaining the position of the inboard and outboard wheel bearings and any spacer, the axle spindle nut assembly may be used to provide a clamp force to compress the wheel bearings, and any bearing spacer, to a predetermined level. A wheel comprising a rim with a mounted tire is mounted on a plurality of wheel studs of the wheel hub and is removably attached thereto via nuts.

As is known in the art, for normal operation of the wheel end assembly to occur, the wheel bearing assembly and surrounding components must be lubricated with grease or oil. Therefore, the wheel end assembly also must be sealed to prevent leakage of the lubricant out of the wheel end assembly, and also to prevent contaminants from entering the wheel end assembly, both of which could be detrimental to its performance. To ensure sealing of the wheel end assembly a hub cap is mounted on an outboard end of the wheel hub adjacent to and outboard from the axle spindle nut assembly, and a main seal is rotatably mounted on an inboard end of the wheel hub and the wheel bearing assembly in abutment with the axle spindle, resulting in a closed or sealed wheel end assembly.

It has been desirable to sense and monitor operating conditions of components associated with the wheel ends of heavy-duty vehicles, such as components of the wheel bearing assemblies or wheels, to determine if potential problems or wheel end conditions with any components associated with the wheel ends exist or have arisen. For example, it has been desirable to monitor vibration experienced by components associated with the wheel end, as a consistently high level of vibration may indicate insufficient lubrication within the wheel end assembly and/or improper functioning of the wheel bearing assembly, as well as potential problems with one or more tire(s)/rim(s) of the wheel(s) mounted on the wheel hub of the wheel end assembly.

In the event that a wheel end condition(s) is discovered, it may be possible to stop operation of the heavy-duty vehicle and perform maintenance on the vehicle to repair or replace problematic wheel end components before failure of these components occurs. When damage or failure of a wheel end component occurs, there may be compounding issues associated with the condition, such as damage to surrounding components, which can greatly increase the cost and time to repair the affected components of the wheel end. Thus, when the heavy-duty vehicle can be stopped and the affected components of the wheel end can be repaired or replaced before failure occurs, it may be possible to significantly reduce the cost and time that is required to repair the affected components.

Heavy-duty vehicles have conventionally employed wheel end sensors, and prior art methods of utilizing the same, incorporated into the wheel ends or associated components of the vehicle to sense or detect such wheel end conditions. The wheel end sensors are typically mounted on or within components associated with the wheel ends, such as the wheel hubs or the hub caps of the wheel end assemblies. Alternatively, the wheel end sensors can be mounted on the axles of the heavy-duty vehicle. Prior art methods for detecting heavy-duty vehicle wheel end conditions utilizing such wheel end sensors have employed accelerometers integrated therein that measure vertical acceleration, i.e., acceleration in a direction upwards from the ground or road surface, of components of the vehicle, such as axles, spindles thereof, or wheel hubs, to attempt to determine the existence of such wheel end conditions. The wheel end sensors employed with prior art methods for detecting heavy-duty vehicle wheel end conditions have been utilized to both monitor operating conditions of the heavy- duty vehicle, such as wheel speed or suspension height, as well as attempt to determine the existence of such wheel end conditions.

Such prior art methods for detecting heavy-duty vehicle wheel end conditions, while generally suitable for their intended purposes, have potential disadvantages, drawbacks, and limitations. More specifically, such prior art methods typically are not desirably accurate, robust, and/or reliable in detecting wheel end conditions associated with components of the wheel ends of the heavy-duty vehicle, potentially resulting in a heavy-duty vehicle operator being unable to specifically determine what component(s) associated with the wheel end(s) is experiencing a problem(s), if any, when alerted to an operating condition above a predetermined limit, indicating a potential wheel end condition, or potentially resulting in the vehicle operator ignoring such an alert because of a lack of confidence in the method's ability to determine the existence of a wheel end condition. For example, in prior art methods for detecting heavy-duty vehicle wheel end conditions that utilize wheel end sensors that employ accelerometers to monitor operating conditions of the heavy-duty vehicle and sense or detect such wheel end conditions, data from vertical acceleration at the axle or wheel hub has been conventionally used to attempt to determine the existence of a wheel end condition. However, while use of such methods and data may indicate an imbalance of one or more tires of the wheels of the wheel ends of the heavy-duty vehicle, the methods are typically incapable of alerting a vehicle operator of other issues or problems with the tires and/or other components of the vehicle. Moreover, such prior art methods typically require several readings/scans and/or numerous detectors or instruments per sensor to monitor various operating conditions of the vehicle and detect a potential wheel end condition.

Such disadvantages, drawbacks, and limitations of the prior art methods of detecting heavy- duty vehicle wheel end conditions make it desirable to develop a method for detecting heavy-duty vehicle wheel end conditions with relatively increased accuracy, robustness, and reliability in detecting such wheel end conditions associated with components of the wheel ends of the heavy-duty vehicle as compared to prior art methods for detecting heavy-duty vehicle wheel end conditions. This increases a vehicle operator's confidence in and acceptance of the method and enables early detection of specific potential problems associated with such components, thereby allowing a vehicle operator to address such conditions and minimize compounding issues associated with the conditions and improving overall vehicle safety, as well as reducing vehicle operational and maintenance costs. Moreover, it is desirable to develop a method for detecting heavy-duty vehicle wheel end conditions that enables detection of one or more wheel end conditions associated with one or more components of the wheel ends of heavy-duty vehicles, as well as enables monitoring of one or more operating conditions associated with the wheel ends, such as wheel speed, via a single signal or reading from a single instrument or detector of the wheel end sensor. This minimizes energy consumption of the wheel end sensor, minimizes cost and complexity of the wheel end sensor, reduces the overall cost of operating the heavy-duty vehicle, and improves market competitiveness of the method for detecting heavy-duty vehicle wheel end conditions as compared to prior art methods for detecting heavy-duty vehicle wheel end conditions. The method for detecting heavy-duty vehicle wheel end conditions of the disclosed subject matter satisfies these needs and overcomes the above described disadvantages, drawbacks, and limitations, as will now be described.

### BRIEF DESCRIPTION OF THE DISCLOSED SUBJECT MATTER

An objective of the disclosed subject matter is to provide a method for detecting heavy-duty vehicle wheel end conditions that has relatively increased accuracy, robustness, and reliability in detecting such wheel end conditions associated with components of the wheel ends of the heavy-duty vehicle as compared to prior art methods for detecting heavy-duty vehicle wheel end conditions.

Another objective of the disclosed subject matter is to provide a method for detecting heavy- duty vehicle wheel end conditions that increases a vehicle operator's confidence in and acceptance of the method and enables early detection of specific potential problems associated with such components.

Yet another objective of the disclosed subject matter is to provide a method for detecting heavy-duty vehicle wheel end conditions that allows a vehicle operator to address wheel end conditions to minimize compounding issues associated with the conditions and improve overall vehicle safety, as well as reduce vehicle operational and maintenance costs.

Another objective of the disclosed subject matter is to provide a method for detecting heavy- duty vehicle wheel end conditions that enables detection of one or more wheel end conditions associated with one or more components of the wheel ends of heavy-duty vehicles, as well as enables monitoring of one or more operating conditions associated with the wheel ends, via a single signal or reading from a single instrument or detector of the wheel end sensor.

Yet another objective of the disclosed subject matter is to provide a method for detecting heavy-duty vehicle wheel end conditions that minimizes energy consumption of the wheel end sensor, minimizes cost and complexity of the wheel end sensor, reduces the overall cost of operating the heavy-duty vehicle, and improves market competitiveness of the method as compared to prior art methods for detecting heavy-duty vehicle wheel end conditions.

These objectives and others are achieved by the method for detecting heavy-duty vehicle wheel end conditions of the disclosed subject matter, which includes the steps of: providing a wheel end sensor with sensor instrumentation; mounting the wheel end sensor to a rotatable component associated with a wheel end of the heavy-duty vehicle; collecting a signal from the sensor instrumentation of the wheel end sensor during operation of the heavy-duty vehicle, the signal being a tangential acceleration signal; processing the signal via suitable means to obtain a metric; and comparing the metric to a predetermined limit to determine whether a wheel end condition exists.

### BRIEF DESCRIPTION OF THE SEVERAL VIEWS OF THE DRAWINGS

An exemplary embodiment of the disclosed subject matter, illustrative of the best mode in which Applicant has contemplated applying the principles, is set forth in the following description and is shown in the drawings.

FIG. 1 is fragmentary cross-sectional perspective view of a portion of an axle spindle and a wheel end assembly of a wheel end of a heavy-duty vehicle;

FIG. 2 is a schematic representation of a driver-side and curb-side wheel end of a heavy-duty vehicle that each include a wheel end assembly with a wheel mounted thereto that is rotatably mounted on an axle of the vehicle, showing a wheel end sensor with sensor instrumentation that is utilized according to an exemplary embodiment method for detecting heavy-duty vehicle wheel end conditions of the disclosed subject matter mounted on a wheel hub of the wheel end assembly of the driver-side wheel end;

FIG. 2A is a schematic representation of the wheel end assembly and wheel of the driver-side wheel end and wheel end sensor of FIG. 2, showing weights for alleviating tire imbalance mounted to the wheel;

FIG. 3 is an enlarged schematic representation of the sensor instrumentation of the wheel end sensor shown in FIGS. 2 and 2A;

FIG. 4 is a flowchart showing an overview of method steps of the exemplary embodiment method for detecting heavy-duty vehicle wheel end conditions of the disclosed subject matter;

FIG. 5 is a graph showing a signal containing a metric of an example wheel end condition obtained and processed according to an Example I of the exemplary embodiment method for detecting heavy-duty vehicle wheel end conditions of the disclosed subject matter that is overlayed with a signal containing a metric of a healthy wheel end also obtained and processed according to Example I, as well as a predetermined limit indicating the example wheel end condition or fault; and

FIG. 6 is a graph showing a signal containing a metric of an example wheel end condition obtained and processed according to an Example II of the exemplary embodiment method for detecting heavy-duty vehicle wheel end conditions of the disclosed subject matter that is overlayed with a signal containing a metric of a healthy wheel end also obtained and processed according to Example II, as well as a predetermined limit indicating the example wheel end condition or fault.

Similar numerals and characters refer to similar parts throughout the drawings.

### DETAILED DESCRIPTION OF THE DISCLOSED SUBJECT MATTER

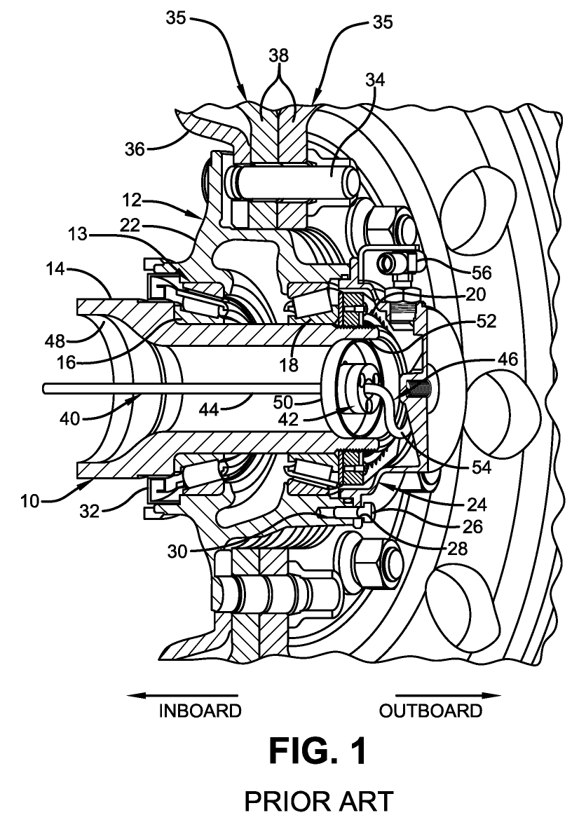

In order to better understand the method for detecting heavy-duty vehicle wheel end conditions of the disclosed subject matter, a wheel end of a heavy-duty vehicle, and components thereof, is shown in FIG. 1, and will now be described. Reference herein shall be made generally to a heavy-duty vehicle for purpose of conciseness and clarity, with the understanding that such reference includes trucks, tractor-trailers or semi-trailers, trailers thereof, and the like.

One or more axles 10 typically depend from and extend transversely across a heavy-duty vehicle (not shown) in a known manner. Axle 10 includes a central tube (not shown). An axle spindle 14 is integrally formed with or otherwise rigidly attached, such as via welding, to each end of the central tub of axle 10. A wheel end assembly 12 is rotatably mounted on each axle spindle 14 of axle 10, as will be described in detail below. For purposes of conciseness and clarity, only one axle spindle 14 of axle 10 and its respective wheel end assembly 12 will be described herein.

Wheel end assembly 12 includes a wheel bearing assembly 13 having an inboard wheel bearing 16 and an outboard wheel bearing 18 immovably mounted on the outboard end of axle spindle 14. A spindle nut assembly 20 threadably engages the outboard end of axle spindle 14 and secures inboard wheel bearing 16 and outboard wheel bearing 18 in place. A wheel hub 22 of wheel end assembly 12 is rotatably mounted on inboard wheel bearing 16 and outboard wheel bearing 18 in a manner known in the art, and thus rotates about axle spindle 14.

A hub cap 24 is mounted on the outboard end of wheel hub 22 via a plurality of bolts 26, each one of which passes through a respective one of a plurality of openings 28 formed in the hub cap, and threadably engages a respective one of a plurality of aligned threaded openings 30 formed in the wheel hub. In this manner, hub cap 24 closes the outboard end of wheel hub 22, and thus the outboard end of wheel end assembly 12. A main continuous seal 32 is rotatably mounted on the inboard end of wheel hub 22 and closes the inboard end of the wheel hub, and thus the inboard end of wheel end assembly 12. In a typical heavy-duty vehicle dual-wheel configuration that employs drum brakes, a plurality of threaded bolts 34 are used to mount a brake drum 36 and a pair of wheel rims 38 of respective wheels 35 on wheel hub 22 of wheel end assembly 12. Each one of a pair of tires (not shown) of wheels 35 are mounted on a respective one of wheel rims 38 of the wheels. Disc brakes (not shown) rather than drum brakes may be mounted on wheel end assembly 12 in a manner known in the art.

For purposes of completeness, wheel end assembly 12 is shown with components of a tire inflation system 40 integrated therein. A central bore 48 is formed in axle spindle 14 of axle 10, through which a pneumatic conduit 44 of tire inflation system 40 extends toward an outboard end of axle spindle 14. Pneumatic conduit 44 is fluidly connected to and extends between a vehicle air supply located on the heavy-duty vehicle, such as an air tank (not shown), and a rotary union 42. Rotary union 42 is shown attached to a plug 50 that is press-fit in a machined counterbore 52 formed in central bore 48 at an outboard end of axle spindle 14. Rotary union 42 facilitates the connection of pneumatic conduit 44, a static component, to an air tube assembly 46, a rotatable component that rotates with wheel 35. In alternative heavy-duty vehicle configurations, rotary union 42 can be attached to/incorporated into other components of the heavy-duty vehicle, such as hub cap 24.

Air tube assembly 46 includes a first tube 54 that is fluidly connected at one of its ends to rotary union 42 inside of hub cap 24, and is fluidly connected at its other end to a tee fitting 56, which passes through and is secured to the hub cap. Additional air tubes (not shown) are fluidly connected to and extend from each one of two outlets of tee fitting 56 outside of hub cap 24 to each one of a respective pair of tires (not shown) mounted on wheel rims 38 of wheels 35. In this manner, air passes from the vehicle air supply, through pneumatic conduit 44, rotary union 42, first tube 54, hub cap 24 and tee fitting 56, and ultimately to the tires of wheels 35.

As described above, it has been desirable to sense and monitor operating conditions of components associated with the wheel ends of the heavy-duty, such as wheel hub 22 of wheel end assembly 12, inboard wheel bearing 16 and outboard wheel bearing 18 of wheel bearing assembly 13, and/or the tires or rims 38 of wheels 35. For example, it has been desirable to sense and monitor the vibration experienced by such components in order to determine if potential problems or wheel end conditions associated with any of the components exist or have arisen. Wheel end sensors (not shown) have been mounted to or within components associated with the wheel ends of heavy-duty vehicles to sense and monitor such operating conditions to determine if potential problems or wheel end conditions with components of the wheel end exist or have arisen. For example, such wheel end sensors have been externally mounted on wheel hub 22 and hub cap 24 of wheel end assembly 12 and wheel rims 38 of wheels 35, have been mounted inside of the wheel hub, have been mounted within the hub cap, and have been mounted on axle spindle 14 and the central tube of axle 10. Such wheel end sensors have employed prior art methods for detecting heavy-duty vehicle wheel end conditions utilizing sensor instrumentation (not shown) associated with/integrated into the sensors. The sensor instrumentation senses or detects such operational conditions and generates signals thereof, which in turn are processed via suitable means, such as via a central processing unit ("CPU") or processor integrated into the sensor, to determine if undesirable levels of the sensed operating condition exists and alert a driver of a potential issue or wheel end condition associated with one or more components of the wheel end of the heavy-duty vehicle.

Such prior art methods for detecting heavy-duty vehicle wheel end conditions, while generally suitable for their intended purposes, have potential disadvantages, drawbacks, and limitations. More specifically, such prior art methods typically are not desirably accurate, robust, and/or reliable in detecting wheel end conditions associated with components of the wheel ends of the heavy-duty vehicle, such as methods that utilize vertical acceleration to attempt to determine the existence of such wheel end conditions. This potentially results in a heavy-duty vehicle operator being unable to specifically determine what component(s) associated with the wheel end(s) is experiencing a problem(s), if any, in the event that the vehicle operator is alerted to an operating condition above a predetermined limit, indicating a potential wheel end condition, or potentially results in the vehicle operator ignoring such an alert because of a lack of confidence in the method's ability to determine the existence of a wheel end condition. Moreover, such prior art methods typically require several readings/scans and/or numerous detectors or instruments per wheel end sensor to monitor the various operating conditions, such as vehicle speed, and detect such wheel end conditions. The method for detecting heavy-duty vehicle wheel end conditions of the disclosed subject overcomes the disadvantages, drawbacks, and limitations of prior art methods for detecting heavy-duty vehicle wheel end conditions, and will now be described.

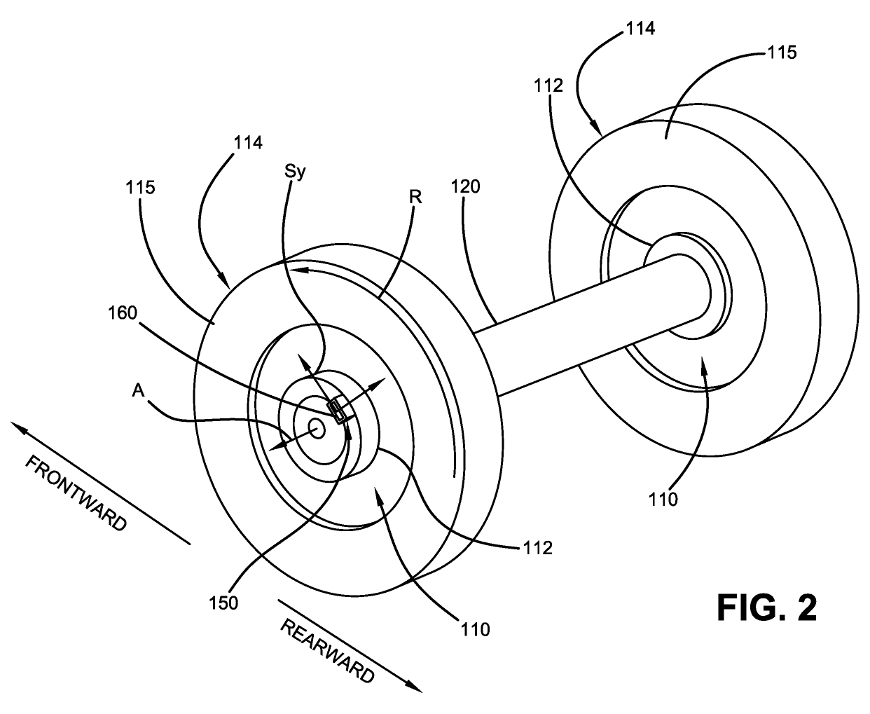

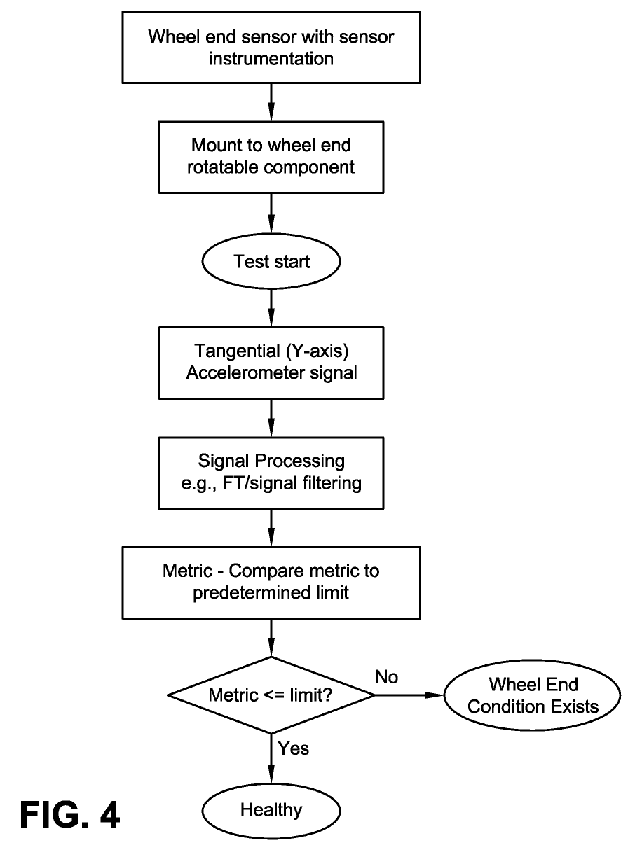

The exemplary embodiment method for detecting heavy-duty vehicle wheel end conditions of the disclosed subject matter and examples thereof, as well as the environment in which it operates, are shown in FIGS. 2-6. With particular reference to FIG. 4, the exemplary embodiment method for detecting heavy-duty vehicle wheel end conditions of the disclosed subject matter generally includes the steps of providing a wheel end sensor with sensor instrumentation, mounting the wheel end sensor on a rotatable component associated with a wheel end of a heavy-duty vehicle, collecting a signal from the sensor instrumentation in the form of vibration along an axis tangential to the axis of rotation of the rotatable component ("tangential acceleration signal") (see FIG. 2), processing the signal, such as via Fourier Transform ("FT"), e.g., a Fast Fourier Transform ("FFT"), and/or signal filtering, e.g., band-pass, low-pass, high-pass, or band-stop filtering, to obtain a metric, and comparing the metric to a predetermined limit to determine if a wheel end condition of one or more components associated with the wheel end of the heavy-duty vehicle exists, the steps of which will be described in greater detail below.

With reference to FIGS. 2 and 2A, in an example wheel end configuration employing a wheel end sensor 150 utilized with the exemplary embodiment method for detecting heavy-duty vehicle wheel end conditions of the disclosed subject matter, the wheel end sensor is shown mounted on a wheel hub 112 of a wheel end assembly 110 of a heavy-duty vehicle. Wheel hub 112 is rotatably mounted on an axle spindle (not shown) of an axle 120 (FIG. 2) via inboard and outboard wheel bearings (not shown) of a wheel bearing assembly (not shown) disposed on the axle spindle, similarly to rotatable mounting of wheel hub 22 of wheel end assembly 12 on axle spindle 14 of axle 10, as described above, such that it rotates relative to a central axis A (FIGS. 2 and 2A) extending axially through the axle. A wheel 114 comprising a tire 115 mounted on a rim (not shown) is mounted on wheel hub 112 via a plurality of wheel studs (not shown) extending from the wheel hub. As wheel hub 112 rotates about central axis A, and thus is a rotatable component associated with the wheel end of the heavy-duty vehicle, wheel end sensor 150, which is mounted on the wheel hub, also rotates relative to the central axis during operation of the heavy-duty vehicle. It is to be understood that wheel end sensor 150 can be mounted to or within rotatable components associated with the wheel end of the heavy-duty vehicle different than wheel hub 22, such as a hub cap (not shown), or the rim or tire 115 of wheel 114 mounted on the wheel hub, without affecting the overall concept or operation of the disclosed subject matter.

Wheel end sensor 150 includes sensor instrumentation 160 that is capable of detecting and generating signals based on vibration, such as an accelerometer, along an axis tangential to central board integrated into the wheel end sensor, to a remote receiver for remote processing, for example, to an external server operated by the fleet. The tangential acceleration signal is preferably processed to convert the signal from a time-domain representation to a frequency-domain representation to provide the metric. Alternatively, the signal can be processed via signal filtering to provide the metric. It is to be understood that the tangential acceleration signal could be processed by other processing means than those described to provide a metric used to determine whether one or more wheel end conditions of one or more components associated with the wheel end(s) of the heavy-duty vehicle exist or have arisen without affecting the overall concept or operation of the disclosed subject matter.

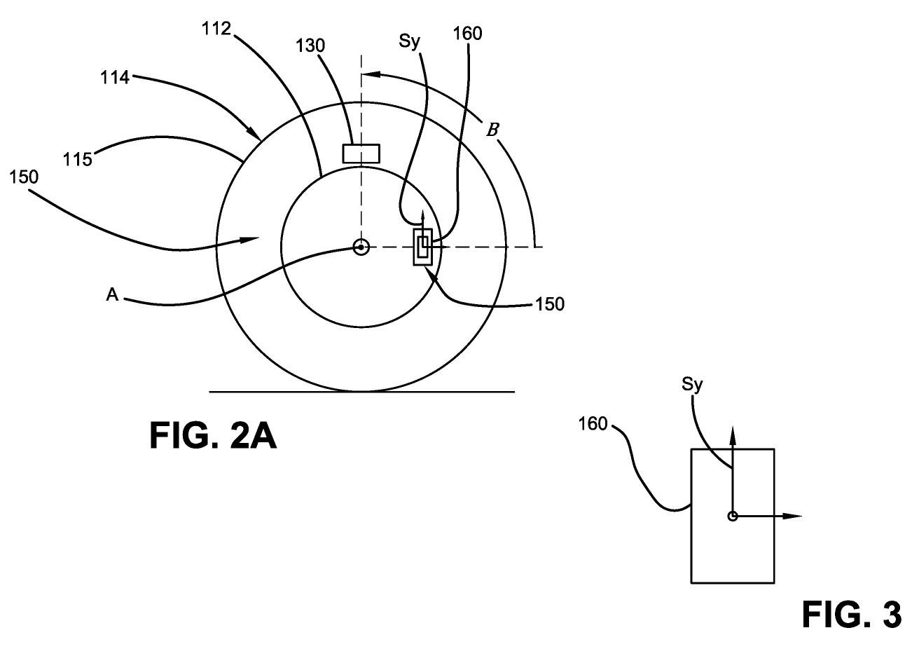

axis A ("tangential acceleration") about which wheel hub 22, and thus the sensor instrumentation, rotates in a direction R (FIG. 2) during forward movement of the heavy-duty vehicle, as indicated by reference character Sy in FIGS. 2, 2A, and 3. Once sensor instrumentation 160 of wheel end sensor 150 detects and generates the tangential acceleration signal, the signal is processed via a suitable processing means to provide a metric used to determine whether one or more wheel end conditions of one or more components associated with the wheel end(s) of the heavy-duty vehicle exist. The tangential acceleration signal is preferably processed via a CPU of a main circuit board integrated into wheel end sensor 150, via a CPU of a circuit board wired or otherwise operatively connected to the wheel end sensor located at a remote location on the heavy-duty vehicle, such as in the cab of a truck, or the tangential acceleration signal may be wirelessly transmitted, such as via an R/F circuit

The metric in turn is compared to a predetermined limit to determine whether a wheel end condition associated with one or more components of the wheel end exists. Depending on the particular wheel end condition being analyzed, the metric, as well as the predetermined limit, can be expressed or presented as a Root Mean Square ("RMS") amplitude of the signal, can be expressed as the processed signal maximum response, or can be expressed as another suitable statistic of the signal that can be used to detect the wheel end condition, such as the Mean Square, the Kurtosis, or other measures of signal energy. It is to be understood that the processed signal can be expressed via different forms without affecting the overall concept or operation of the disclosed subject matter. The limit may be predetermined by accumulation of one or more signals by sensor instrumentation 160 of wheel end sensor of a wheel end of the heavy-duty vehicle that include an unacceptable particular operating condition under perfect smooth road conditions in a test environment and/or during real road operation of the heavy-duty vehicle, and subsequent processing via suitable means, such as FFT and/or signal filtering. The predetermined limit associated with each particular operating condition can be catalogued or stored in internal memory of wheel end sensor 150 or may be catalogued or stored in an external database for comparison with the metric(s) obtained during operation of the heavy-duty vehicle, such as a remote server in communication with the wheel end sensor. It is to be understood that the predetermined limit indicating the existence of a particular wheel end condition may be determined and catalogued or stored via other methods and/or locations than those described without affecting the overall concept or operation of the disclosed subject matter. It is also contemplated that potential problems or wheel end conditions associated with one or more components of a particular wheel end could be determined based on comparison of processed tangential acceleration signal(s) and metrics of the particular wheel end to tangential acceleration signals and metrics of other wheel end sensors 150 mounted to or within rotatable components associated with other wheel ends of the heavy-duty vehicle without affecting the overall concept or operation of the disclosed subject matter.

With reference to FIG. 4, if the response of the metric is above the predetermined limit, the metric indicates a wheel end condition, whereas a response of the metric that is below the limit indicates a healthy condition. Depending on the particular wheel end condition being analyzed, the predetermined limit may be speed-dependent, i.e., determined based on the particular speed of the heavy-duty vehicle during detection of the tangential accelerometer signal from which the metric is based, or non-speed-dependent, and/or the frequency range may be broad or narrow. For example, if the vibrations indicating a particular wheel end condition are impulsive, they spread across a large frequency range and will require a relatively broad frequency band. However, if the vibration indicating a particular wheel end condition is pure sinusoidal motion, then the frequency band will be relatively narrow. Moreover, determination of the existence of a particular wheel end condition according to the exemplary embodiment method for detecting heavy-duty vehicle wheel end conditions of the disclosed subject matter may be dependent on the relationship of the particular wheel end condition with other wheel end conditions. For example, detection of a particular wheel end condition could be dependent on the disqualification of one or more other wheel end conditions. It is contemplated that the method for detecting heavy-duty vehicle wheel end conditions of the disclosed subject matter may be utilized to analyze and detect non-specific, generalized issues with components of the wheel end(s) of the heavy-duty vehicle, in addition to detecting specific wheel end conditions. For example, in the event that a tangential acceleration signal detected by sensor instrumentation 160 of wheel end sensor 150 has such high energy content at all frequencies that it overwhelms the wheel end sensor's ability to determine the specific wheel end condition, such as if tire 115 of wheel 114 is significantly damaged from road debris during operation of the heavy-duty vehicle, the wheel end sensor can be programmed to provide a generalized full band fault to alert a vehicle operator to inspect the particular wheel end, and components thereof, associated with the full band fault. Moreover, it is further contemplated that the method for detecting heavy-duty vehicle wheel end conditions of the disclosed subject matter can be utilized to detect peak faults, i.e., one-off, non-reoccurring tangential acceleration signals detected by sensor instrumentation 160 during vehicle operation, such as a tangential acceleration signal detected when tire 115 of wheel 115 encounters a pothole during operation of the vehicle, and disregard such peak faults to prevent the vehicle operator from being alerted to the same.

Because the exemplary embodiment method for detecting heavy-duty vehicle wheel end conditions of the disclosed subject matters employs sensor instrumentation 160 of wheel end sensor 150 that is capable of detecting and generating signals based on tangential acceleration Sy (FIGS. 2, 2A, and 3) during operation of the heavy-duty vehicle, as opposed to vertical acceleration, which has been conventionally utilized to generate a signal in prior art methods of detecting heavy-duty vehicle wheel end conditions, the method provides relatively increased accuracy, robustness, and reliability in detecting wheel end conditions associated with components of the wheel ends of the heavy-duty vehicle as compared to prior art methods for detecting heavy-duty vehicle wheel end conditions. This increases a vehicle operator's confidence in and acceptance of the method and enables early detection of specific potential problems associated with such components, thereby allowing a vehicle operator to address the wheel end conditions and minimize compounding issues associated with the conditions and improving overall vehicle safety, as well as reducing vehicle operational and maintenance costs. Moreover, the tangential acceleration signals obtained according to the exemplary embodiment method for detecting heavy-duty vehicle wheel end conditions of the disclosed subject matter can be processed such that a single measured tangential acceleration signal can be utilized to monitor one or more operating conditions associated with the wheel ends, such as wheel speed, as well as detect multiple wheel end conditions associated with one or more components of the wheel ends of heavy- duty vehicle, thereby minimizing energy consumption of the wheel end sensor, minimizing cost and complexity of the wheel end sensor, and reducing the overall cost of operating the heavy-duty vehicle.

Having now described the exemplary embodiment method for detecting heavy-duty vehicle wheel end conditions of the disclosed subject matter generally, specific examples employing the method of the disclosed subject matter to detect specific wheel conditions will now be described.

### Example I: Tire Imbalance

In an example utilizing the exemplary embodiment method for detecting heavy-duty vehicle wheel end conditions of the disclosed subject matter ("Example I"), the method is employed to detect whether a tire imbalance condition exists for one or more tires of the wheels of the wheel ends of the heavy-duty vehicle. As is known in the art, it is desirable to balance the tires associated with the wheel ends of heavy-duty vehicles by evenly distributing weight around the circumferences of the wheels to minimize wheel wobbling and vibrations of the wheel. As is also known in the art, a small degree of tire imbalance of a single wheel of the heavy-duty vehicle can potentially negatively impact operation of a vehicle, such as by decreasing fuel economy of the vehicle, increasing tread wear of the unbalanced tire and/or other tires associated with other wheels of the vehicle, decreasing ride comfort of the vehicle, and increasing stress and wear on components of the axle/suspension systems of the heavy-duty vehicle. Therefore, it is desirable to detect any tire imbalance(s) of the wheels of the heavy-duty vehicle in order to enable correction of the imbalance(s) to minimize or eliminate these potential negative impacts on the vehicle. With reference to FIG. 2A, such tire imbalances are typically alleviated by mounting one or more weights 130 on wheel 114, such as on the rim of the wheel.

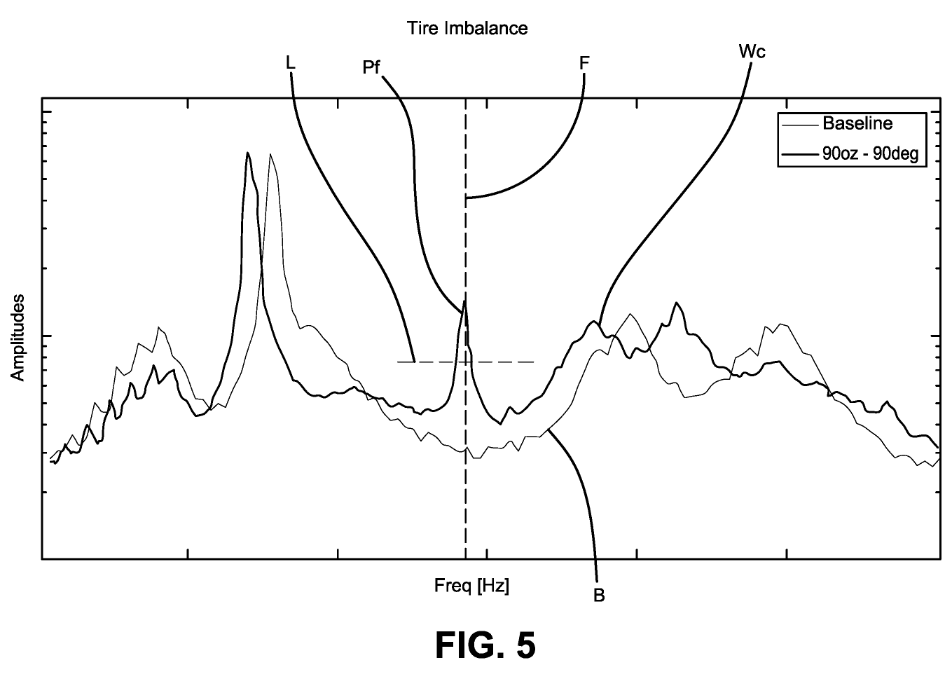

In the exemplary embodiment method for detecting heavy-duty vehicle wheel end conditions of the disclosed subject matter according to Example I, sensor instrumentation 160 of wheel end sensor 150 is programmed to periodically collect tangential acceleration signals during operation of the heavy-duty vehicle, which in turn are processed by a CPU associated with the wheel end sensor via FFT to convert the signal to a frequency-domain representation within a selected frequency range, as depicted by a processed signal We in FIG. 5. With reference to FIG.2A, wheel end sensor 150, and thus sensor instrumentation 160, is shown located at a positioning angle p of 90 degrees relative to weights 130 on the particular component of the wheel end about central axis A extending axially through axle 10 utilized to initially balance tire 115 of wheel 114. It is to be understood that wheel end sensor 150, and thus sensor instrumentation 160, can be positioned at positioning angles p different than 90 degrees relative to weights 130 without affecting the overall concept or operation of the disclosed subject matter. With continued reference to FIG. 5, processed signal We within the selected frequency range is compared to a baseline signal B also within the selected frequency range. Baseline signal B is generated via one or more tangential acceleration signals obtained by sensor instrumentation 160 of wheel end sensor 150 of a wheel end of the heavy-duty vehicle that includes a balanced tire, or alternatively, a tire with a maximum acceptable level or degree of imbalance, under smooth road conditions in a test environment and/or during real road operation of the heavy-duty vehicle. The metric of the tire imbalance condition is depicted by a peak response Pf within processed signal We at a frequency F associated with the condition, which is compared by wheel end sensor 150 to a predetermined limit depicted by a response limit L at frequency F associated with the condition. Peak response Pf is preferably expressed or presented as RMS amplitude, but can also be expressed or presented as a frequency peak taken directly from an FFT. Response limit L is preferably determined by extensive testing to provide reliable identification of a wheel end condition without generating false positives, thus increasing the reliability of the exemplary embodiment method for detecting heavy-duty vehicle wheel end conditions and increasing a vehicle operator's confidence in and acceptance of the method.

If peak response Pf of the metric at frequency F is greater than response limit L at frequency F, as shown in FIG. 5, tire 114 of wheel 115 is experiencing a tire imbalance condition and the vehicle operator can be alerted to the condition. The vehicle operator can be alerted to the tire imbalance condition via wired or wireless transmission to a visual or audible indicator located in the cab of the vehicle, or alternatively, can be communicated to a remote system, such as a server operated by the fleet, to enable the vehicle operator to stop operation of the vehicle and perform maintenance on the vehicle to correct the tire imbalance condition to minimize or eliminate potential negative impacts on the vehicle associated with such an imbalance, such as minimizing potential damage to tire 114 or other components associated with the wheel end. In contrast, if peak response Pf at frequency F is less than or equal to response limit L at frequency F, then the tire balance of the particular tire is acceptable and the vehicle operator is not alerted to a tire imbalance condition.

In the event that a tire imbalance condition exists, depending on the intensity of peak response Pf at frequency F, it may be possible to determine the degree of imbalance, for example, the weight imbalance in ounces (oz) of the particular tire based on comparison to reference data stored in the internal memory of wheel end sensor 150, or alternatively, stored in an external database, such as a remote server in communication with the wheel end sensor, for comparison with the obtained peak response during operation of the heavy-duty vehicle.

In this manner, the exemplary embodiment method for detecting heavy-duty vehicle wheel end conditions of the disclosed subject matter according to Example I enables detection of a tire imbalance condition(s) for one or more tires of the wheels associated with the wheel ends of the heavy-duty vehicle, such as tire 114 of wheel 115, during operation of the vehicle, and alerts the operator of the same. This is turn enables the vehicle operator to stop operation of the heavy-duty vehicle and perform maintenance on the vehicle to address the tire imbalance condition(s).

### Example II: Tire Flat Spot (Brake Skid Wear)

In another example utilizing the exemplary embodiment method for detecting heavy-duty vehicle wheel end conditions of the disclosed subject matter ("Example II"), the method is employed to detect whether a tire flat spot condition exists for one or more tires of the wheels of the wheel ends of the heavy-duty vehicle. As is known in the art, many kinds of irregular tire wear conditions can be experienced by a tire of a wheel of a heavy-duty vehicle during operation of the vehicle, such as depression wear, diagonal wear, flat spot wear or brake skid wear, shoulder step wear, and cupping/scallop wear. With regard to a tire flat spot condition, when the tire of the wheel associated with a particular wheel end of the vehicle exhibits a localized flat spot on the tire, this can be indicative of potential issues with the braking system of the heavy-duty vehicle, such as an unbalanced brake system or frozen brake lines, which caused the wheel to lock-up and the tire to be dragged across the road surface to create the localized flat spot on the tire. Such potential issues with the brake system can potentially cause damage to other brake system components and/or components associated with the wheel end of the heavy-duty vehicle, as well as potentially pose a safety hazard. Therefore, it is desirable to detect when a tire flat spot condition exists in order to enable the brakes to be inspected and any potential issues with the braking system to be remediated, as well as enable repair/replacement of the tire.

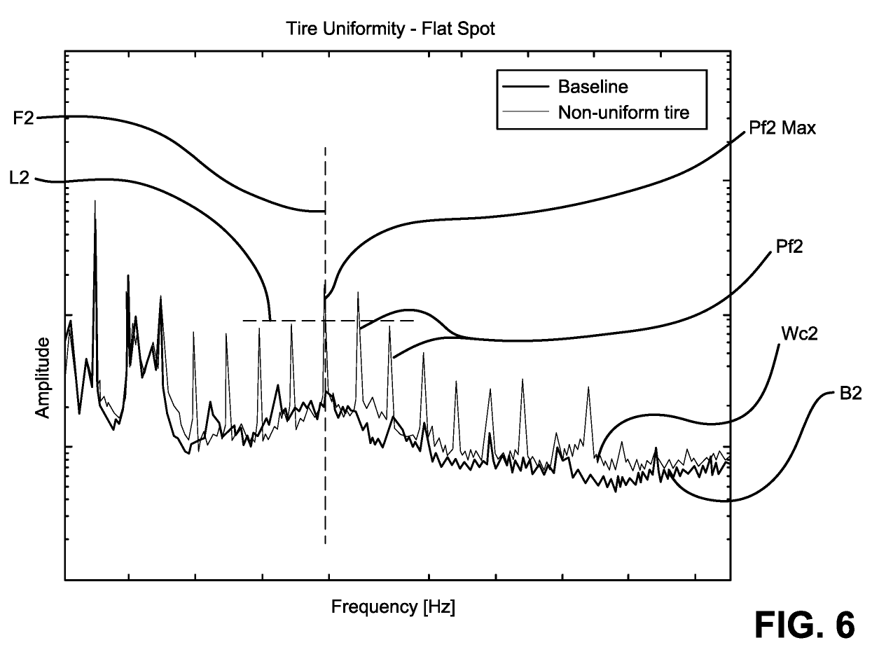

In the exemplary embodiment method for detecting heavy-duty vehicle wheel end conditions of the disclosed subject matter according to Example II, sensor instrumentation 160 of wheel end sensor 150 is programmed to periodically collect tangential acceleration signals during operation of the heavy-duty vehicle, which in turn are processed by the CPU associated with the wheel end sensor via FFT to convert each signal to a frequency-domain representation within a selected frequency range, as depicted by a processed signal Wc2 in FIG. 6. With continued reference to FIG. 6, processed signal Wc2 within the selected frequency range is compared to a predetermined limit depicted by a response limit L2 at a frequency F2 associated with the condition. Baseline signal B2 shows a tangential acceleration signal obtained by sensor instrumentation 160 of wheel end sensor 150 of a wheel end of the heavy-duty vehicle that includes an undamaged tire, or alternatively a tire with a maximum acceptable level or degree of flat spot irregularity, under perfect smooth road conditions in a test environment and/or during real road operation of the heavy-duty vehicle. The metric of the flat spot condition is depicted by a series of peak responses Pf2,Pf2Max within the processed signal Wc2. The highest peak response associated with the flat spot condition, Pf2Max, at a frequency F2 associated with the peak, is compared by wheel end sensor 150 to response limit L2 at frequency F2.

If peak response Pf2Max at frequency F2 is greater than response limit L2 at frequency F2, as shown in FIG. 6, tire 114 of wheel 115 is experiencing a tire flat spot condition and the vehicle operator can be alerted to the condition. The vehicle operator can be alerted to the tire flat spot condition via wired or wireless transmission to a visual or audible indicator located in the cab of the vehicle, or alternatively, can be communicated to a remote system, such as a server operated by the fleet, to enable the vehicle operator to stop operation of the vehicle and perform maintenance on the vehicle to inspect for potential issues with the braking system of the heavy-duty vehicle, perform maintenance on the braking system, and/or repair/replace tire 114 of wheel 115, to minimize or eliminate potential negative impacts on the vehicle associated with the tire flat spot condition. In contrast, if peak response Pf2Max at frequency F2 is less than or equal to response limit L2 at frequency F2, then tire 114 is not experiencing a tire flat spot condition and the vehicle operator is not alerted to a tire flat spot condition. In the exemplary embodiment method for detecting heavy- duty vehicle wheel end conditions of the disclosed subject matter according to Example II, detection of a tire flat spot condition may be greatly improved by disqualification of a wheel bearing fault condition associated with the inboard or outboard wheel bearings of the wheel bearing assembly of wheel end assembly 110 according to the method of the disclosed subject matter prior to tire flat spot analysis. Response limit L2 is preferably determined by extensive testing to provide reliable identification of a wheel end condition without generating false positives, thus increasing the reliability of the exemplary embodiment method for detecting heavy-duty vehicle wheel end conditions and increasing a vehicle operator's confidence in and acceptance of the method.

In this manner, the exemplary embodiment method for detecting heavy-duty vehicle wheel end conditions of the disclosed subject matter according to Example II enables detection of a tire flat spot condition(s) for one or more tires of the wheels associate with the wheel ends of the heavy-duty vehicle, such as tire 114 of wheel 115, during operation of the heavy-duty vehicle, and alerts the vehicle operator of the same. This is turn enables the vehicle operator to stop operation of the heavy- duty vehicle and/or perform maintenance on the vehicle to address the tire flat spot condition(s) and/or any related problems, such as potential problems with one or more components of the vehicle braking system.

### CONCLUSION

Therefore, the method for detecting heavy-duty vehicle wheel end conditions of the disclosed subject matter enables detection of potential problems or wheel end conditions associated with one or more components of the wheel ends of heavy-duty vehicles, such as those pertaining to wheel bearing health, tire imbalance, tire uniformity and health, and/or other wheel end conditions, using one or more wheel end sensors mounted to respective components of the wheel ends of the vehicle. The method for detecting heavy-duty vehicle wheel end conditions of the disclosed subject matter provides relatively increased accuracy, robustness, and reliability in detecting such wheel end conditions associated with components of the wheel ends as compared to prior art methods for detecting heavy-duty vehicle wheel end conditions. This increases a vehicle operator's confidence in and acceptance of the method and enables early detection of specific potential problems associated with such components, thereby allowing a vehicle operator to address the wheel end conditions and minimize compounding issues associated with the wheel end conditions and improving overall vehicle safety, as well as reducing vehicle operational and maintenance costs. Moreover, the method for detecting heavy-duty vehicle wheel end conditions of the disclosed subject matter enables detection of one or more wheel end conditions associated with one or more components of the wheel ends of heavy-duty vehicles, as well as enables monitoring of one or more operating conditions associated with the wheel ends, such as wheel speed, via a single signal or reading from a single instrument or detector of the wheel end sensor. This minimizes energy consumption of the wheel end sensor, minimizes cost and complexity of the wheel end sensor, reduces the overall cost of operating the heavy-duty vehicle, and improves market competitiveness of the method for detecting heavy-duty vehicle wheel end conditions as compared to prior art methods for detecting heavy-duty vehicle wheel end conditions.

It is to be understood that the method for detecting heavy-duty vehicle wheel end conditions of the disclosed subject matter may include additional or different steps than those shown and described without affecting the overall concept or operation of the disclosed subject matter. It is also to be understood that the method for detecting heavy-duty vehicle wheel end conditions of the disclosed subject matter may be utilized to analyze and detect wheel end conditions other than those described, such as a wheel bearing health condition indicating an issue with inboard and/or outboard wheel bearings utilized to rotatably mount wheel hub 112 on the axle spindle, without affecting the overall concept or operation of the disclosed subject matter. It is to be further understood that the method for detecting heavy-duty vehicle wheel end conditions of the disclosed subject matter finds application in all types of wheel ends known to those skilled in the art, including wheel ends with different components than those shown and described, without affecting the overall concept or operation of the disclosed subject matter. While reference herein has been made generally to a heavy- duty vehicle for the purpose of convenience, it has been with the understanding that such reference ncludes trucks, tractor-trailers or semi-trailers, trailers thereof, and the like.

Accordingly, the method for detecting heavy-duty vehicle wheel end conditions of the disclosed subject matter is simplified; provides an effective, safe, inexpensive, and efficient method, which achieves all the enumerated objectives; provides for eliminating difficulties encountered with prior art methods for detecting heavy-duty vehicle wheel end conditions; and solves problems and obtains new results in the art.

In the foregoing description, certain terms have been used for brevity, clarity, and understanding, but no unnecessary limitations are to be implied therefrom beyond the requirements of the prior art, because such terms are used for descriptive purposes and are intended to be broadly construed. Moreover, the description and illustration of the disclosed subject matter is by way of example, and the scope of the disclosed subject matter is not limited to the exact details shown or described.

Having now described the features, discoveries and principles of the disclosed subject matter; the manner in which the method for detecting heavy-duty vehicle wheel end conditions of the disclosed subject matter is used and installed; the characteristics of the construction, arrangement, and method steps; and the advantageous, new and useful results obtained; the new and useful structures, devices, elements, arrangements, parts and combinations, and methods are set forth in the appended claims.

What is claimed is:

1. A method for detecting a wheel end condition of a heavy-duty vehicle comprising the steps of:
a. providing a wheel end sensor, said wheel end sensor including sensor instrumentation;
b. mounting the wheel end sensor to a rotatable component associated with a wheel end of said heavy-duty vehicle;
c. collecting a signal from said sensor instrumentation of said wheel end sensor during operation of the heavy-duty vehicle, said signal being a tangential acceleration signal;
d. processing said signal via suitable means to obtain a metric; and
e. comparing said metric to a predetermined limit to determine whether said wheel end condition exists.

2. The method for detecting a wheel end condition of a heavy-duty vehicle of claim 1, wherein said signal is processed via Fast Fourier Transform to obtain said metric.

3. The method for detecting a wheel end condition of a heavy-duty vehicle of claim 1, wherein said signal is processed via signal filtering.

4. The method for detecting a wheel end condition of a heavy-duty vehicle of claim 3, wherein said signal filtering is band-pass filtering, low-pass filtering, high-pass filtering, or band-stop filtering.

5. The method for detecting a wheel end condition of a heavy-duty vehicle of claim 1, wherein said sensor instrumentation is an accelerometer.

6. The method for detecting a wheel end condition of a heavy-duty vehicle of claim 1, wherein said rotatable component is a hub cap, a wheel hub, a rim, or a tire of said heavy-duty vehicle.

7. The method for detecting a wheel end condition of a heavy-duty vehicle of claim 1, wherein said wheel end condition is a tire imbalance condition, a tire flat spot condition, a bearing health condition, a full band fault, or a peak fault.

8. The method for detecting a wheel end condition of a heavy-duty vehicle of claim 1, wherein said predetermined limit is stored in an internal memory of said wheel end sensor.

9. The method for detecting a wheel end condition of a heavy-duty vehicle of claim 1, wherein said predetermined limit is stored in an external database removed from said wheel end sensor.

10. The method for detecting a wheel end condition of a heavy-duty vehicle of claim 9, wherein said external database is a remote server in communication with said wheel end sensor.

11. The method for detecting a wheel end condition of a heavy-duty vehicle of claim 1, further comprising the method step of disqualifying an alternative wheel end condition based on comparison of said processed signal with a second predetermined limit prior to comparing said metric to said predetermined limit to determine whether said wheel end condition exists.

12. The method for detecting a wheel end condition of a heavy-duty vehicle of claim 1, wherein said signal is compared to multiple predetermined limits to disqualify one or more wheel end conditions or determine whether multiple wheel end conditions exist.

13. The method for detecting a wheel end condition of a heavy-duty vehicle of claim 1, wherein said signal is processed via a CPU integrated into said wheel end sensor to provide said metric.

14. The method for detecting a wheel end condition of a heavy-duty vehicle of claim 1, wherein said metric is expressed as an RMS amplitude of said signal.

15. The method for detecting a wheel end condition of a heavy-duty vehicle of claim 1, wherein said metric is expressed as a signal maximum response of said signal.

16. The method for detecting a wheel end condition of a heavy-duty vehicle of claim 1, further comprising the step of providing an alert if it is determined that said wheel end condition exists upon comparison of said metric with said predetermined limit.

17. The method for detecting a wheel end condition of a heavy-duty vehicle of claim 16, wherein said alert is a visual indicator or an audible indicator located in a cab of said heavy-duty vehicle that is operatively connected to said wheel end sensor.

18. The method for detecting a wheel end condition of a heavy-duty vehicle of claim 16, wherein said alert is communicated to a remote server.

19. The method for detecting a wheel end condition of a heavy-duty vehicle of claim 1, wherein said predetermined limit is dependent on a speed of said heavy-duty vehicle.

20. The method for detecting a wheel end condition of a heavy-duty vehicle of claim 1, wherein said predetermined limit is not dependent on a speed of said heavy-duty vehicle.
